(19) United States
(12) Patent Application Publication
(10) Pub. No.: US 2008/0162479 A1
(43) Pub. Date: Jul. 3, 2008

(54) MEMORY CARD SYSTEM AND METHOD FOR TRANSMITTING BACKGROUND INFORMATION THEREOF

(76) Inventor: Won-Chul Ju, Seoul (KR)

Correspondence Address: F. CHAU & ASSOCIATES, LLC, 130 WOODBURY ROAD, WOODBURY, NY, 11797, US

(21) Appl. No.: 11/692,510

(22) Filed: Mar. 28, 2007

(30) Foreign Application Priority Data
Jan. 2, 2007 (KR) 2007-00229

(51) Int. Cl. G06F 3/00

(52) U.S. Cl. 707/7

(57) ABSTRACT

A memory card system, and a method of transmitting background information, in which the memory card system includes a host generating a background command; and a memory card providing the host with background information on whether the memory card supports a background operation, in response to the background command. Because the memory card system performs the background operation during an idle period, an operation of the memory card to be performed later can be prepared and an actual time for an operation such as read and write of the memory card can be reduced, so that performance of the memory card is considerably improved.

### CROSS-REFERENCE TO RELATED APPLICATION

This patent application claims priority under 35 U.S.C. § 119 of Korean Patent Application No. 2007-229, filed Jan. 2, 2007, the entire contents of which are hereby incorporated by reference.

### BACKGROUND OF THE INVENTION

The present disclosure relates to a memory card system and, more particularly, to a memory card system for transmitting background information of a memory card.

Recently, memory cards such as a secure digital (SD) card, a multi-media card (MMC), an extreme digital (xD) card, a compact flash (CF) card, a smart media (SM) card, and a memory stick have been widely used. Those memory cards are used in conjunction with various kinds of hosts. Examples of the hosts include a cellular phone, an MP3 player, a portable media player (PMP), and a digital camera.

FIG. 1 is a block diagram illustrating a general memory card system. Referring to FIG. 1, a memory card system 1 includes a host 10 and a memory card 20. The host 10 includes a host controller 11, and a host connection unit 12. The memory card 20 includes a card connection unit 21, a card controller 22, and a memory 23.

The host connection unit 12 and the card connection unit 21 include a plurality of pins. Those pins include a command pin, a data pin, a clock pin, and a power pin. The number of pins varies depending on the kind of memory card 20. For example, the SD memory card has nine pins.

The host 10 writes data on the memory card 20, or reads data stored in the memory card 20. The host controller 11 transmits a command (CMD) for example, a write command, a clock signal (CLK) generated from a clock generator (not shown) within the host 10, and data (DAT) to the memory card 20 through the host connection unit 12.

The card controller 22 receives a write command through the card connection unit 21. The card controller 22 stores data in the memory 23 in response to the write command. For example, if the host 10 is a digital camera, image data is stored in the memory 23. There are various kinds of memories 23, and the most frequently used one of the memories 23 is a flash memory.

The conventional memory card is turned off during an idle period during which read and write operations are not performed. Therefore, power consumption is minimized. Because the memory card 1 is turned off and thus performs no operations during the idle period, however, the performance efficiency decreases. If the next operations of the memory card can be prepared during the idle period, the performance of the memory card could be improved.

### SUMMARY OF THE INVENTION

Exemplary embodiments of the present invention provide a memory card system capable of preparing during an idle period for an operation to be performed after the idle period.

Exemplary embodiments of the present invention provide memory card systems including a host generating a background command; and a memory card providing the host with background information on whether the memory card supports a background operation, in response to the background command.

In some exemplary embodiments, the memory card is a secure digital (SD) card, or a multi-media card (MMC). The host transmit the background command to the memory card using a command line. The memory card provides the host with the background information using the command line, and the memory card then transmits the background information to the host using the data line.

In exemplary embodiments of the present invention, memory card systems include a host generating a background command; and a memory card providing the host with background information on whether the memory cad supports a background operation, in response to the background command. The memory card has a change mode to change to an idle mode, after performing the background operation.

In some exemplary embodiments, the host generate a change command to check whether the memory card has the change mode. The host transmits the change command to the memory card using a command line. The memory card provides the host with change information on whether the memory card supports the change operation, using the command line. Otherwise, the memory card transmits change information to the host on whether the memory card supports the change operations, using the data line.

In exemplary embodiments of the present invention, methods for transmitting background information of a memory card system, include: transmitting, by a host, a command for requesting background information to a memory card; and providing the host with the background information on whether the memory card supports a background operation, in response to the background command of the host.

In some exemplary embodiments, the host transmits the background command to the memory card, using a command line. The memory card provides the host with the background information, using the command line. Otherwise, the memory card transmits the background information to the host, using a data line.

In other exemplary embodiments, the methods for transmitting background information of a memory card system further include changing the memory card to an idle state, after the background operation of the memory card is performed.

In other exemplary embodiments, the changing of the memory card to the idle state include: transmitting, by the host, a change command for requesting change information from the memory card; and providing the host with the change information on whether the memory card supports a change operation, in response to the change command of the host. The host transmits the change command to the memory card using a command line. The memory card provides the host with the change information of the memory card using the command line. Otherwise, the memory card transmit the change information of the memory card to the host using a data line.

### BRIEF DESCRIPTION OF THE FIGURES

The accompanying figures are included to provide a further understanding of exemplary embodiments of the present invention, and are incorporated in and constitute a part of this specification. The drawings illustrate the exemplary embodiments of the present invention and, together with the description, serve to explain principles of the present invention. In the figures:

FIG. 1 is a block diagram illustrating a general memory card system;

FIG. 2 is an exterior view illustrating an exterior of an SD card;

FIG. 3 is a diagram showing pin names and descriptions of the SD card of FIG. 2;

FIGS. 4A and 4B are diagrams respectively showing a command format and a response format defined in FIG. 3;

FIGS. 5A through 5C are a block diagram and diagrams for describing a method for transmitting background information of a memory card system according to an exemplary embodiment of the present invention;

FIGS. 6A and 6B are a block diagram and a diagram for describing a method for transmitting background information of a memory card system according to an exemplary embodiment of the present invention; and

FIG. 7 is a flow chart for describing a background operation of a memory card system according to an exemplary embodiment of the present invention.

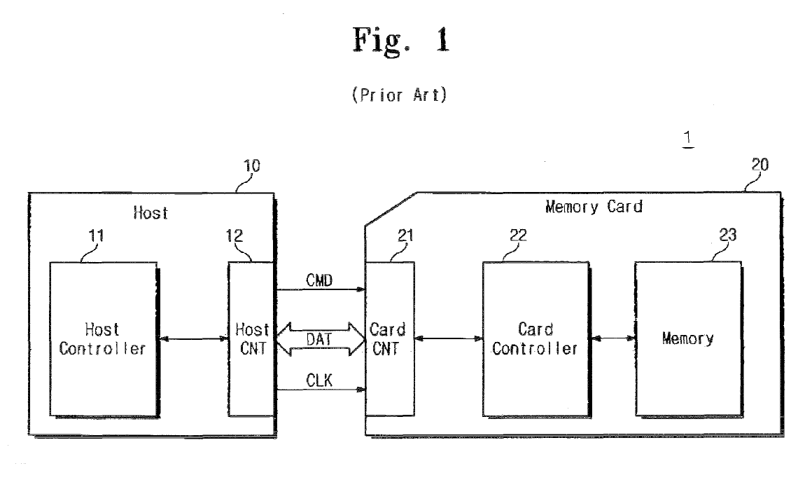

### DETAILED DESCRIPTION OF EXEMPLARY EMBODIMENTS

Exemplary embodiments of the present invention will be described below in more detail with reference to the accompanying drawings. The present invention may, however, be embodied in different forms and should not be constructed as limited to the exemplary embodiments set forth herein. Rather, these exemplary embodiments are provided so that this disclosure will be thorough and complete, and will fully convey the scope of the present invention to those skilled in the art.

Hereinafter, will be described exemplary embodiments of the present invention in conjunction with the accompanying drawings.

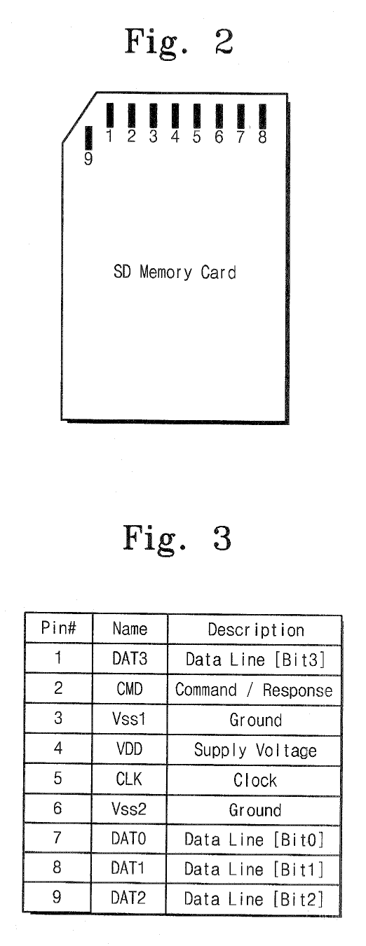

FIG. 2 illustrates an exterior of an SD card among various memory cards, and FIG. 3 illustrates names and descriptions of pins used in the SD card. Referring to FIG. 2, the SD card includes nine pins. Referring to FIG. 3, the SD card has four data pins (pin numbers 1, 7, 8, and 9), one command pin (pin number 2), one clock pin (pin number 5), and three power pins (pin numbers 3, 4, and 6).

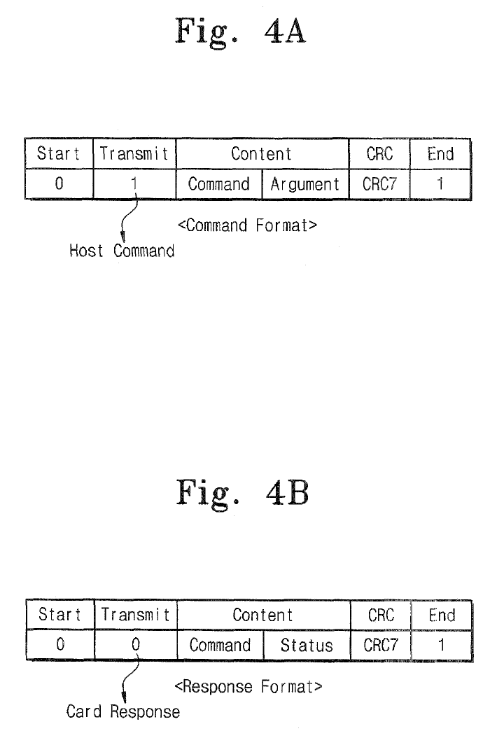

In this exemplary embodiment, a command and a response signal (response) are transmitted through the command pin (pin number 2). In general, the command is transmitted to the memory card back from the host, and the response is transmitted from the memory card to the host. A command format and a response format will be described in detail with reference to FIGS. 4A and 4B.

FIGS. 4A and 4B are exemplary views illustrating command and response formats, respectively. FIG. 4A illustrates a command format, and FIG. 4B illustrates a response format.

Referring to FIG. 4A, the command format includes a start bit, a transmit bit, content, a CRC, and an end bit. In this exemplary embodiment, it is assumed that the command format has 48 bits.

The command format always starts with the start bit. In this exemplary embodiment, the start bit is always defined as ‘0’. The transmit bit is a bit for defining a transmission direction. When the transmit bit is ‘1’, the transmission occurs from the host to the memory card. When the transmit bit is ‘0’, the transmission occurs from the memory card to the host.

The content includes a command and an argument. The command has, for example, six bits. The six-bit command may be decoded into 64 commands. Parts of the 64 commands require an argument (that is, an address). The argument has, for example, 32 bits. Every command is protected by the CRC. The CRC has, for example, seven bits. The end bit is a bit for terminating command transmission. The end bit is always defined as ‘1’.

Referring to FIG. 4B, the response format includes a start bit, a transmit bit, content, a CRC, and an end bit. As can be seen from FIGS. 4A and 4B, the response format is similar to the command format.

That is, the response format always starts with the start bit ‘0’, and the start bit is followed by the transmit bit ‘0’. The content includes a command and a status signal (status). The command has 6 bits, and the status signal has 32 bits. The status signal is a signal for notifying the host of the current status of the memory card.

As described above, the memory card system operates, using a command transmitted by the host to the memory card, a response transmitted by the memory card back to the host, and data transmitted and received between the host and the memory card. A memory card such as an MMC or an SD card performs an initialization process through an identification mode. During the initialization process, the host obtains various host identification information, such as a capacity, a manufacturer, and a serial number.

During an idle period, the memory card system according to an exemplary embodiment of the present invention may prepare for an operation of the memory card to be performed later. The preparation operation of the memory card is called a background operation. In an exemplary embodiment of the present invention, a process of transmitting background information of the memory card is performed during or after the initialization process.

In an exemplary embodiment of the present invention, the host requests background information from the memory card, and the memory card transmits the background information to the host. In this exemplary embodiment, the background information means information on whether the memory card supports the background operation. If the memory card supports the background operation, the host controls the memory card during the idle period, and the memory card performs the background operation in response to a command from the host.

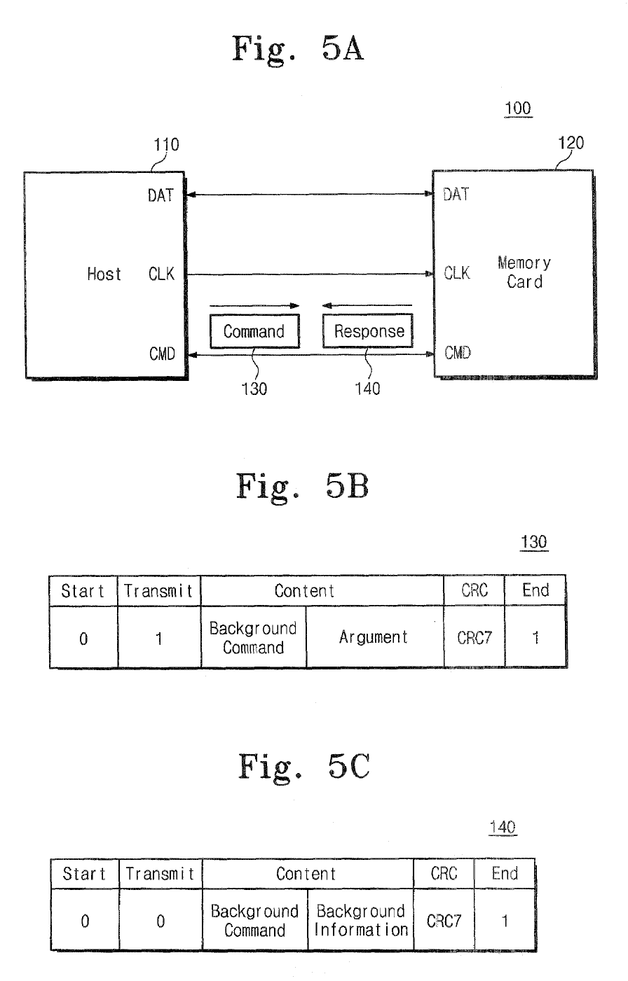

FIGS. 5A, 5B, and 5C are a block diagram and diagrams for describing a method for transmitting background information of a memory card system according to an exemplary embodiment of the present invention. Referring to FIG. 5A, the memory card system 100 includes a host 110 and a memory card 120. The host 110 and the memory card 120 are electrically connected together through a data line, a clock line, and a command line.

In order to request background information from the memory card 120, the host 110 transmits a specific command 130 to the memory card 120 through the command line. Referring to FIG. 5B, the specific command includes a background command. In this exemplary embodiment, the background command is a command defined to request background information of the memory card 120. The background command is a command that is newly defined in this exemplary embodiment of the present invention, in addition to existing commands such as a write command or a read command. The host 110 transmits content including a background command and an argument to the memory card 120.

The memory card 120 includes a nonvolatile memory (not shown) and a memory controller (not shown). The nonvolatile memory comprises a NAND flash memory or a NOR flash memory. The memory controller controls general operations such as a read or write operation of the nonvolatile memory under control of the host 110.

The memory card 120 transmit a specific response 140 back to the host 110 in response to the background command from the host 130. Referring to FIG. 5C, the specific response 140 includes the same background command as that of the specific command 130. Also, the specific response 140 includes background information.

In this exemplary embodiment, the background information is information on whether or not the memory card 120 supports a background operation. The memory card 120 provides background information of the memory card 120 to the host 210 in response to the background command of the host 110.

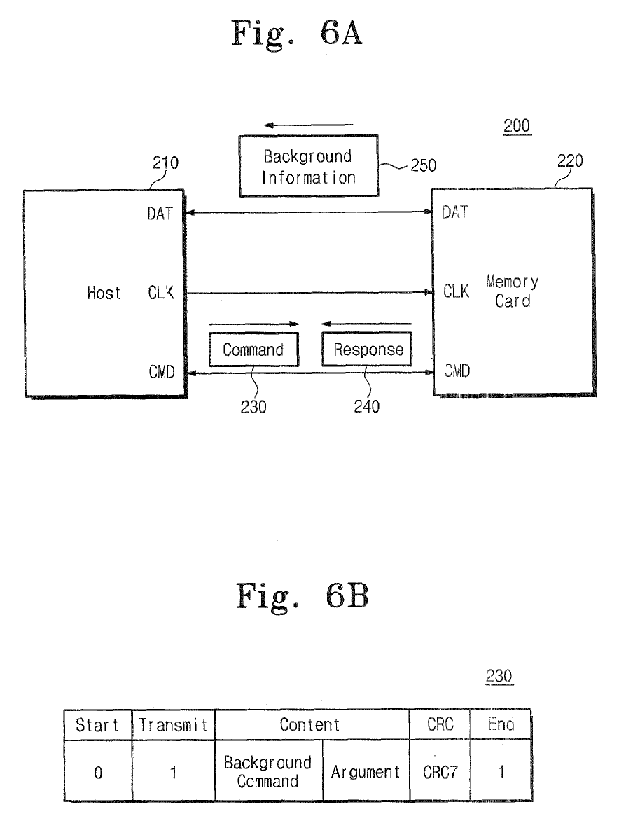

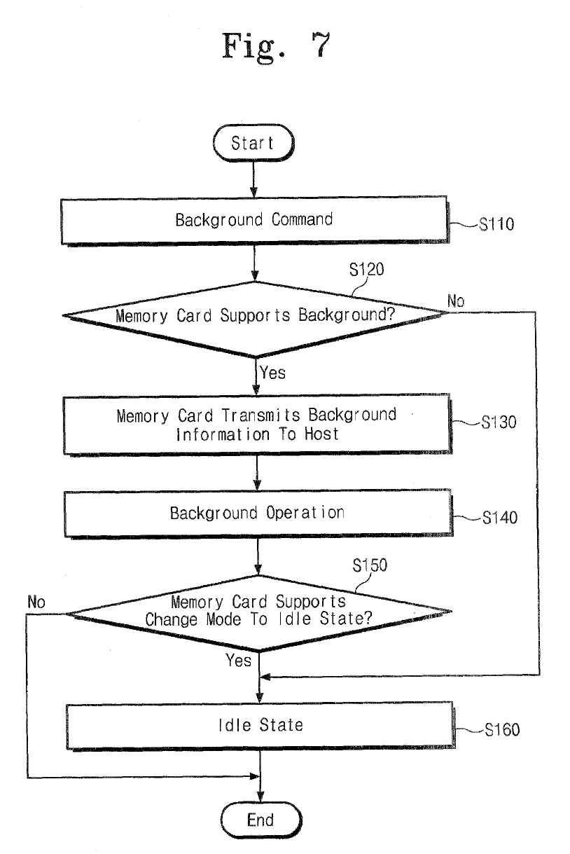

FIGS. 6A and 6B are a block diagram and a diagram, respectively, for describing a method for transmitting background information of a memory card system according to an exemplary embodiment of the present invention. Referring to FIG. 6A, a memory card system 200 includes a host 210 and a memory card 220. The host 210 and the memory card 220 are electrically connected through a data line, a clock line, and a command line. The host 210 transmits a background command 230 to the memory card 220 in the same manner as described above with reference to FIG. 5.

In the memory card system of FIG. 5A, the background information of the specific response 140 is transmitted to the host by using a predetermined number f bits (for example, 32 bits). If the background information exceeds the size of a specific status of the specific response 140, that is, 32 bits, the background information cannot be transmitted all at once. In the exemplary embodiment shown in FIG. 6A, the memory card system 200 can transmit the background information 250 to the host 210 using the data line.

To request the background information, the host 210 transmits a specific command 230 to the memory card 220 through a command line. Referring to FIG. 6B, the specific command 230 includes a background command. In the memory card system 200 illustrated in FIG. 6A, the memory card 220 transmits the background information 250 using the data line.

In this exemplary embodiment, the background information 250 may be transmitted with a compressed password, or using an encryption algorithm for security reasons of the background information. Also, the background information 250 of the memory card 220 may be stored in a memory (not shown) in the memory card 220, or may be stored in a separate storage device (not shown).

The memory card system according to an exemplary embodiment of the present invention performs a background operation. The host determines whether the memory card supports the background operation, prior to the background operation of the memory card. The memory card transmits the background information through the command line or the data line in response to the host request.

FIG. 7 is a flow chart for describing a background operation of a memory card system according to an exemplary embodiment of the present invention. A background operation of the memory card system 100 will now be described with reference to FIGS. 5A through 7.

In operation S110, the host 110 provides the memory card 120 with a background command. The host 110 provides the background command through a command line. In this exemplary embodiments, the background command is a command for informing whether the memory card 120 supports the background operation.

In operation S120, it is determined whether the memory card 120 supports the background operation. When the memory card 120 supports the background operation, the memory provides the host 110 with the background information in operation S130. In contrast, when the memory card 120 does not support the background operation, the memory card 120 enters an idle state in operation S160. Hereinafter, the description is provided on the assumption that the memory card 120 supports the background operation.

In operation S130, the memory card 120 provides the host 110 with the background information in response to the background command of the host 110. The memory card 120 transmits the background information through the command line. As illustrates in FIG. 6, however, the memory card 120 can transmit the background information through the data line.

In operation S140, the memory card 120 performs the background operation. That is, the memory card 120 performs a preparation operation necessary for an operation, such as read or write, to be performed after the idle period. The memory card 120 may reduce the actual time for a read or write operation through the background operation. For example, during the idle period, the memory card 120 may perform an erase operation prior to a write operation, or perform wear leveling or merging in order to equalize the number of write operations and the number of erase operations.

In operation S150, it is determined whether or not the memory card 120 supports a change mode to an idle state. The host 110 provides the memory card 120 with a change command using the command line. The memory card 120 provides the host 110 with change information using the command line or the data line. In this exemplary embodiment, the change information is about whether the memory card can be changed to the idle state after completing the background operation.

The change command and the change information are transmitted between the host 110 and the memory card 120 in the same manner as the transmission of the background command and the background information described with reference to FIGS. 5A through 6. The host 110 may transmit the change command at the same time when providing the background information.

In operation S160, when the memory card 120 supports the change mode to the idle state, the memory card 120 enters the idle state after the background operation. The memory card 120 is then converted to a low power state.

As described above, the memory card notifies the host whether the memory card supports the background operation through the command line or the data line in response to a specific command of the host. The host receives the background information from the memory card, and allows the memory card to perform the background operation.

Also, the memory card system according to an exemplary embodiment of the present invention can perform a change operation to an idle state after the background operation. The memory card notifies the host whether the memory card supports the change operation through the command line or the data line in response to a specific command of the host. The host receives the change information form the memory card, and allows the memory card to change to a lower power state.

According to an exemplary embodiment of the present invention, the memory card system performs a background operation during an idle period, thereby preparing for a memory card operation to be performed later. Since an actual time for an operation such as read and write of the memory card can be reduced according to an exemplary embodiment of the present invention, the performance of the memory card is considerably improved. In addition, the memory card system according to an exemplary embodiment of the present invention can change to an idle state after the background operation, so that power consumption can be reduced.

The above-disclosed subject matter is to be considered illustrative, and not restrictive, and the appended claims are intended to cover all such modifications, enhancements, and other exemplary embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A memory card system comprising:
a host generating a background command; and
a memory card providing the host with background information on whether the memory card supports a background operation, in response to the background command transmitted thereto.

2. The system of claim 1, wherein the memory card is a secure digital card (SD).

3. The system of claim 1, wherein the memory card is a multi-media card (MMC).

4. The system of claim 1, wherein the host transmits the background command to the memory card using a command line.

5. The system of claim 4, wherein the memory card provides the host with the background information using the command line.

6. The system of claim 4, wherein the memory card transmits the background information to the host using a data line.

7. A memory card system comprising:
a host generating a background command; and
a memory card providing the host with background information on whether the memory card supports a background operation, in response to the background command transmitted thereto,
wherein the memory card has a change mode to change to an idle mode, after performing the background operation.

8. The system of claim 7, wherein the host generates a change command to check whether the memory card has the change mode.

9. The system of claim 8, wherein the host transmits the change command to the memory card, using a command line.

10. The system of claim 9, wherein the memory card provides the host with change information on whether the memory card supports the change operation, using the command line.

11. The system of claim 9, wherein the memory card transmits change information on whether the memory card supports the change operation to the host, using a data line.

12. A method for transmitting background information of a memory card system, the method comprising:
transmitting, by a host, a command for requesting background information to a memory card; and
providing the host with the background information on whether the memory card supports a background operation, in response to the background command of the host.

13. The method of claim 12, wherein the host transmits the background command to the memory card, using a command line.

14. The method of claim 13, wherein the memory card provides the host with the background information, using the command line.

15. The method of claim 13, wherein the memory card transmits the background information to the host, using a data line.

16. The method of claim 12, further comprising changing the memory card to an idle state, after the background operation of the memory card is performed.

17. The method of claim 16, wherein in changing of the memory card to the idle state comprises:
transmitting, by the host, a change command for requesting change information from the memory card; and
providing the host with the change information on whether the memory card supports a change operation, in response to the change command of the host.

18. The method of claim 17, wherein the host transmits the change command to the memory card, using a command line.

19. The method of claim 18, wherein the memory card provides the host with the change information of the memory card, using the command line.

20. The method of claim 18, wherein the memory card transmits the change information of the memory card to the host, using a data line.
